(19) United States
(12) Patent Application Publication
(10) Pub. No.: US 2006/0096358 A1
(43) Pub. Date: May 11, 2006

(54) Optical projection tomography microscope

(75) Inventors: Mark E. Fauver, Seattle, WA (US); Alan C. Nelson, Gig Harbor, WA (US)

Correspondence Address: GEORGE A LEONE, SR, 2150 128TH AVENUE, NW, MINNEAPOLIS, MN, 55448, US

(73) Assignees: University of Washington; VisionGate, Inc.

(21) Appl. No.: 10/975,162

(22) Filed: Oct. 28, 2004

(51) Int. Cl. G01N 30/00

(52) U.S. Cl. 73/61.72

(57) ABSTRACT

A rotational system including a cylindrical container with a cylindrical container axis. The cylindrical container is inserted into at least one pair of opposing polymer grippers. A motor is coupled to rotate the cylindrical container.

### FIELD OF THE INVENTION

The present invention is related to optical systems and, more particularly, to optical systems for extended depth-of-field imaging through a cylindrical specimen container.

### BACKGROUND OF THE INVENTION

An optical tomographic device is intended to produce three-dimensional reconstructions of specimens contained in a capillary tube by providing a multitude of “shadowgrams.” A shadowgram, also known in the art as a projection, is a measure of light attenuation along a set of ray paths through the specimen.

To obtain a three-dimensional representation of an object, a microscope objective is axially scanned such that its plane of focus scans through the specimen's thickness. The focal plane of the objective lens can be moved through the specimen while the detector is located in the microscope's image plane. Thus, a projection image can be compiled from a set of discrete focal planes within the specimen, and this compilation is called a pseudo-projection.

Another method for obtaining shadowgrams is to utilize an optical system with an extended depth of field, such that most or all of the object is in focus in a single projection image. A number of methods exist, such as x-ray computerized tomography, that permit the creation shadowgrams from true-projections.

In order to obtain more complete three dimensional information, rotation of a cylindrical specimen container is used to present multiple viewing perspectives. Unfortunately, known mechanisms do not provide a rotational joint that suitably allows high rotational speed combined with ease of use and stability, especially in the case where the cylindrical specimen container comprises a fragile device such as a micro-capillary tube.

Some example descriptions of discrete focal-plane scanning are provided by N Ohyama et al., in U.S. Pat. No. 5,680,484 issued Oct. 21, 1997, entitled “Optical Image Reconstructing Apparatus Capable of Reconstructing Optical Three-Dimensional Image Having Excellent Resolution and S/N Ratio”; by E A Swanson et al., in U.S. Pat. No. 5,321,501 issued Jun. 14, 1994, entitled “Method and Apparatus for Optical Imaging with Means for Controlling the Longitudinal Range of the Sample”; by R E Grosskopf, in U.S. Pat. No. 4,873,653 issued Oct. 10, 1989, entitled “Microscope System for Providing Three Dimensional Resolution”; and by A D Edgar, in U.S. Pat. No. 4,360,885 issued Nov. 23, 1982, entitled “Micro-Optical Tomography.” However, all these methods suffer from low throughput rates due to the stopping and restarting of the moving parts. Another method using true projections is provided by A C Nelson, in U.S. Pat. No. 6,522,775 issued Feb. 18, 2003, entitled Apparatus and Method for Imaging Small Objects in a Flow Stream Using Optical Tomography. This method is inherently high throughput where motion uniformity and control become even more critical.

In overcoming the deficiencies in the state of the art, the present invention takes advantage of the development of polymer grippers. Polymer grippers have been developed for use as holding devices for optical elements such as optical fiber, planar chips, GRIN lenses and filters. Polymer grippers provide self-aligning, snap-in holding with three points of contact. However, known uses for the polymer gripper are believed to be limited to statically holding optical elements in place, without rotation, for splicing, holding within other devices, pre-positioning fibers during manufacture and similar uses.

In contrast to known uses and constructions, the present invention discloses for the first time a system and method for using polymer grippers as a rotational joint in combination with a microcapillary tube. The present invention provides a method and apparatus for using at least one pair of polymer grippers in a system for continuously scanning the focal plane of pseudo-projection or a true-projection optical imaging system along an axis perpendicular to said image plane through the thickness of a specimen during a detector exposure. The process is repeated from multiple perspectives, either in series using a single illumination/detection subsystem, or in parallel using several illumination/detection subsystems, or some combination of series and parallel acquisition. In this way, a set of shadowgrams is generated, which can be input to a tomographic image reconstruction algorithm (such as filtered backprojection) to generate a three-dimensional image. The apparatus described has greater speed and higher signal-to-noise than the prior art described above while providing a means for 3D reconstruction by computer-aided tomographic techniques.

### SUMMARY OF THE INVENTION

The present invention provides a rotational system including a cylindrical container with a cylindrical container axis. The cylindrical container is inserted into at least one pair of opposing polymer grippers. A motor, or other driving mechanism, is coupled to rotate the cylindrical container.

### BRIEF DESCRIPTION OF THE DRAWINGS

FIG. 1 schematically shows an example illustration of cells packed into a cylindrical container as contemplated by an embodiment of the present invention.

FIG. 2 illustrates schematically one embodiment of the present invention, incorporating a microscope objective lens mounted on a piezoelectric translation device for the purpose of generating pseudo-projection shadowgrams.

FIG. 3 schematically shows an example of a point source projection system as contemplated by an embodiment of the present invention, incorporating a point source of light to generate true-projection shadowgrams.

FIG. 4 schematically shows a top view of the example illustration of one embodiment of the present invention, including a cylindrical container mounted onto a set of polymer grippers.

FIG. 5 depicts a side view of the embodiment of FIG. 4.

FIG. 6 illustrates an extrusion method of embedding a specimen in a solid medium, such as a linear polymer medium, as contemplated by one embodiment of the present invention.

### DETAILED DESCRIPTION OF THE PREFERRED EMBODIMENTS

The invention is described herein with respect to specific examples relating to biological cells; however, it will be understood that these examples are for the purpose of illustrating the principals of the invention, and that the invention is not so limited. For illustrative purposes, an object such as a biological cell may be labeled with at least one tagged molecular probe, and the measured amount and location of this probe may yield important information about the disease state of the cell, including, but not limited to, various cancers such as lung, colon, prostate, breast, cervical and ovarian cancers, or infectious agents.

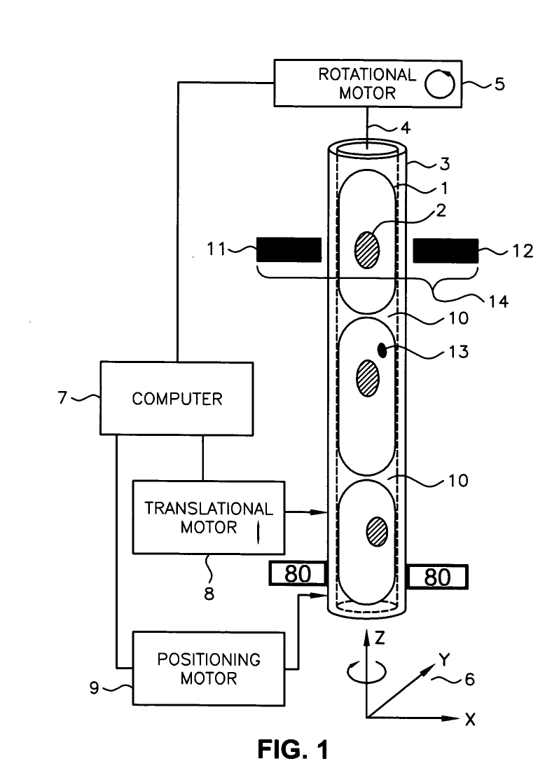

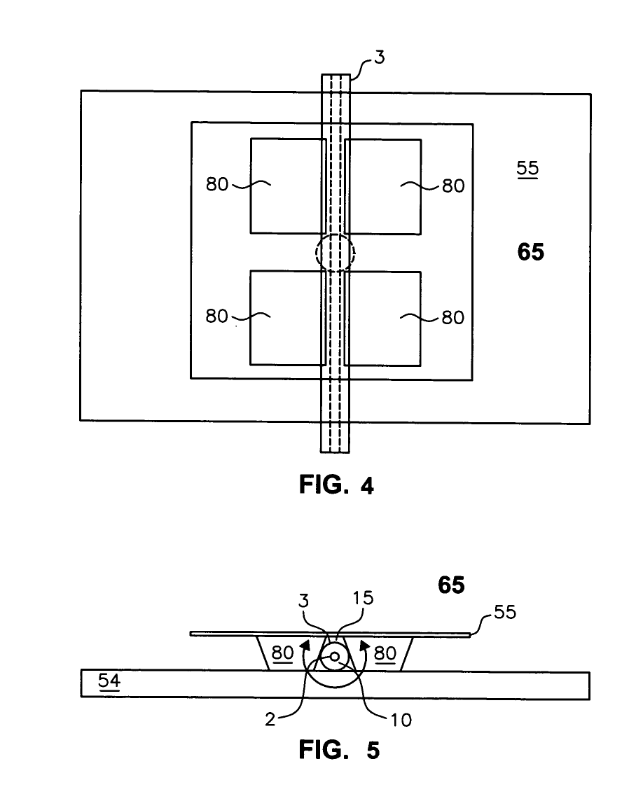

Referring now to FIG. 1, there shown schematically is an example illustration of cells packed into a cylindrical container as contemplated by an embodiment of the present invention. In this example embodiment, a section of the cylindrical container 3 is filled with cells 1 that are packed rigidly into the tube. Each of the cells may include a nucleus 2. The cylindrical container 3 has a central axis 4 oriented with reference to a coordinate system 6 having coordinates in the x, y and z-directions. A gripping apparatus comprising a plurality of pillars 80 serves to constrain the cylindrical container 3. The gripping mechanism is shown in detail below with respect to FIG. 4 and FIG. 5. In some instances, at least one molecular probe 13 may be bound within the cell. A computer 7 is coupled to provide control signals to a motor 5 and a translational motor 8. It will be recognized that equivalent arrangements of one or more motors, gears or fluidics or other means of generating motion may also be employed to achieve the necessary translational and rotational motion of the capillary tube or other substrate. In some cases, one or more of the motors may be replaced by manual positioning devices or gears or by other means of generating motion such as hydraulic or piezoelectric transducers. The axis of translation is the z-axis, and rotation is around the z-axis. The positioning motor 9 is coupled to move the cell in a plane defined by the x, y-axes, substantially perpendicular to the central axis for the purpose of centration, as necessary.

It will be recognized that the curved surface of the cylindrical container will act as a cylindrical lens and that the resulting focusing effect may not be desirable in a projection system. Those skilled in the art will appreciate that the bending of photons by the cylindrical container can be eliminated if the spaces between (a) the illumination source 11 and the cylindrical container and (b) between the cylindrical container surface and the detector 12 are filled with a material 10 whose index of refraction matches that of the cylindrical container and that the cylindrical container can be optically coupled, with oil or a gel, for example, to the space filling material. When index of refraction differences are necessary, for instance due to material choices, then at minimum the index of refraction difference should only exist between flat surfaces in the optical path. Illumination source 11 and detector 12 form a source-detector pair 14. Note that one or more source-detector pairs may be employed.

Consider the example of cells packed into a cylindrical container. The cells may preferably be packed single file so that they do not overlap. The maximum density of packing whole cells of about 100 microns in diameter into a cylindrical container, such as, for example, a microcapillary tube with inside diameter of 100 microns or less, can be roughly 100 cells per centimeter of cylindrical container length. For bare nuclei of about 20 microns in diameter, the packing can be roughly 500 nuclei per centimeter of cylindrical container length where the cylindrical container diameter is proportional to the object size, about 20 microns in this case. Thus, within several centimeters of cylindrical container length, a few thousand non-overlapping bare nuclei can be packed. To move in the z-direction, the cylindrical container may be translated along its central axis 4. Or conversely, the objects can be caused to flow in the z-direction through the capillary tube. Moving the cylindrical container in the x, y-directions relative to an objective lens allows objects within the tube to be centered, as necessary, in the reconstruction cylindrical container of the optical tomography system. By rotating the cylindrical container around its central axis 4, a multiplicity of radial projection views can be produced.

One advantage of translating a cylindrical container filled with cells, that are otherwise stationary inside the cylindrical container, is that objects of interest can be stopped, and then rotated, at speeds that permit nearly optimal exposure for optical tomography on a cell-by-cell basis. That is, the signal to noise ratio of the projection images can be improved to produce better images than may be usually produced at constant translational speeds and direction typical of flow systems. Objects that are not of interest can be moved out of the imaging system swiftly, so as to gain overall speed in analyzing cells of interest in a sample consisting of a multitude of cells. Additionally, the ability to stop on an object of interest, and then rotate as needed for multiple projections, nearly eliminates motion artifacts. Still further, the motion system can be guided at submicron movements and can advantageously be applied in a manner that allows sampling of the cell at a resolution finer than that afforded by the pixel size of the detector. More particularly, the Nyquist sampling criterion could be achieved by moving the system in increments that fill half a pixel width, for example. Similarly, the motion system can compensate for the imperfect fill factor of the detector, such as may be the case if a charge-coupled device with interline-transfer architecture is used.

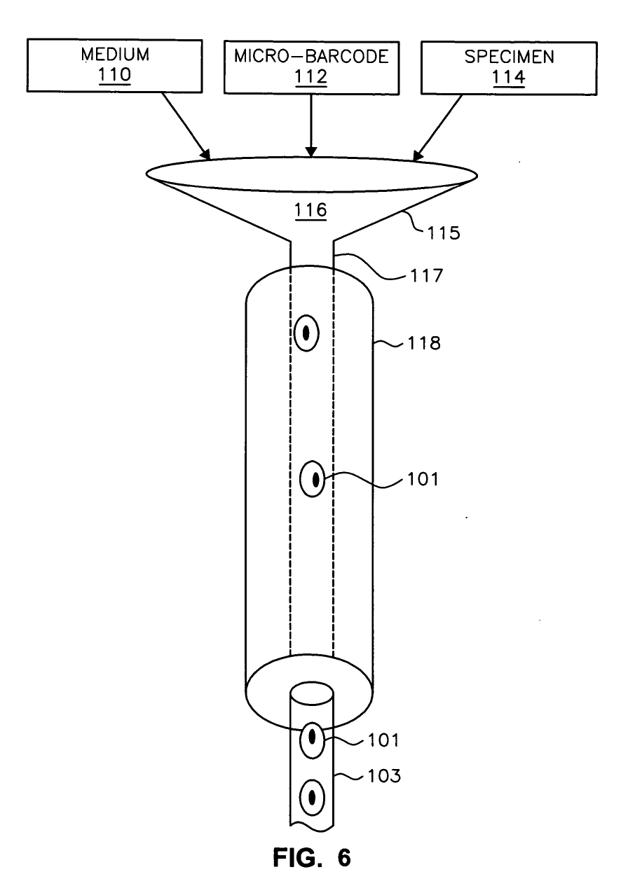

In another embodiment, the cylindrical container 3 may be replaced with a solid medium in a cylindrical shape, and having cells embedded within such as described with reference to FIG. 6. This solid medium comprises a polymer or UV-cure polymer, or cell mounting medium formed, for example, into a cylindrical shape, creating an optically clear cylindrical container, like that of a polymer optical fiber, with cells embedded. The embedding may be accomplished by extruding a liquid suspension or by other means.

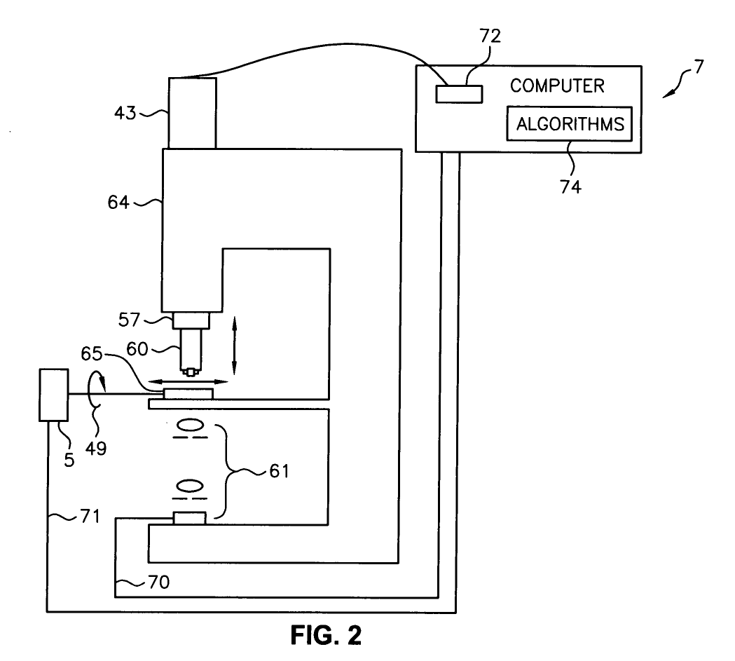

Referring now to FIG. 2, one embodiment of the present invention, incorporating a microscope objective lens mounted on a piezoelectric translation device is schematically shown. The embodiment here is further described in U.S. patent application Ser. No. 10/716,744 to Fauvre et al., filed Nov. 18, 2003, entitled METHOD AND APPARATUS OF SHADOWGRAM FORMATION FOR OPTICAL TOMOGRAPHY, incorporated herein by reference and assigned to the same assignees as the present invention.

A piezoelectric transducer (PZT) 57 is used to move an objective lens 60 an axial distance of about 40 microns or more. In one useful embodiment, a micro-objective positioning system provides a suitable actuator 57, which is driven up and down along the z axis of coordinate system 6. In this embodiment, it may be used with a high numerical aperture objective, mounted on an standard transmission microscope 64 with a video camera 43 attached and a computer-controlled light source and condenser lens assembly 61. The computer-controlled condenser and light source 50 may advantageously be a light source including one or more incandescent bulbs, an arc lamp, a laser, or a light emitting diode. Computer control signals 70 are linked to the computer-controlled condenser and light source 50 for controlling light modulation.

The output from the camera 43 is stored in a computer memory 72. A specimen assembly 65 can be translated along the x or y axes of coordinate system 6. In addition, a cylindrical container 3, as for example a microcapillary tube, containing the specimen can be rotated about its “θ” axis 49, via a motor 5 that can be computer-controlled. As used herein microcapillary tube is defined as a capillary tube having a diameter where the field of view for microscopic imaging is comparable to the capillary tube diameter. A gripping apparatus comprising a plurality of pillars 80 is schematically indicated. Since the gripping apparatus is described in more detail below, the entire apparatus has not been shown in order to simplify the figure for understanding of the main components. In an example embodiment the motor 5 is controlled by control signals 71 as provided by the computer 7. For high speed applications other controls may be added in order to reduce vibrations during an axial scan.

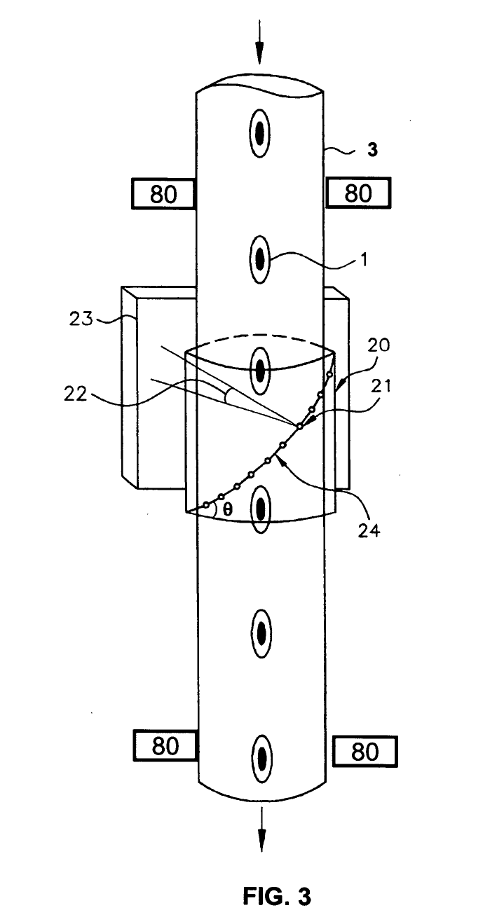

Referring now to FIG. 3, there shown schematically is an example of a point source projection system as contemplated by an embodiment of the present invention. The point source 21 generates a beam of photons 22, where the beam of photons 22 is typically cone or fan shaped, or with suitable beam converging lenses, it can become a parallel beam. A cell flowing along the tube axis while the tube is rotated will sweep through helical pattern. A variety of geometric configurations, depending in part on the speed of the electronics and the cell velocity along the z-axis, can achieve non-overlapping projection signals at the detector.

With the fixed optical point source 21, in conjunction with an opposing detector 23 mounted around a circumference of the tube, it is possible to sample multiple projection angles through the entire cell 1 as it flows past the sources when the tube is being rotated. By timing of the emission or readout, or both, of the light source and attenuated transmitted and/or scattered and/or emitted light, each detected signal will coincide with a specific, known position along the axis in the z-direction of the flowing cell at a particular rotation angle. In this manner, a cell 1 flowing with known velocity along a known rotating axis perpendicular to a light source that is caused to emit or be detected in a synchronized fashion, can be optically sectioned with projections through the cell that can be reconstructed to form a 2D slice in the x-y plane. By stacking or mathematically combining sequential slices, a 3D picture of the cell will emerge. It is also possible to combine the cell motion with the positioning of the light source (or sources) around the flow axis to generate data that can be reconstructed, for example, in a helical manner to create a 3D picture of the cell. Reconstruction can be done either by stacking contiguous planar images reconstructed from linear (1D) projections using fan-beam reconstruction algorithms, or from planar (2D) projections directly using cone-beam reconstruction algorithms.

Referring now particularly to FIG. 4 and FIG. 5, the specimen assembly 65 comprises a microscope slide 54, which serves as an optically clear substrate, a cylindrical container 3, index matching material 15, a coverslip 55 and a gripping apparatus comprising at least one pair of opposing pillars 80. The cylindrical container 3 preferably comprises, for example, a microcapillary tube with inner and outer radii of approximately 50 and 150 microns respectively, inserted into at least one pair of opposing polymer grippers comprising at least one pair of opposing pillars 80 fabricated on a suitable glass substrate such as the microscope slide 54. The pair of opposing polymer grippers serves to constrain the motion of the cylindrical container 3 along the x and y-axes as defined by tube coordinate system 6. The pair of opposing polymer grippers also functions as a rotation joint for the cylindrical container 3 that keeps lateral motion orthogonal to the tube axis restrained to, for example, within 1-2 microns. In one example embodiment, a 150 micron outer diameter (OD) provides a tight fit in the pair of opposing polymer grippers, though there is a chance of stiction occurring if any residual polyimide is left on the outside of the microcapillary tube. The pillars 80 form an inverted v-groove with the microscope slide 54, so that the fiber comprising the cylindrical container 3 can be clipped into place, with the inverted v-groove pressing the cylindrical container 3 against the glass substrate. The cylindrical container 3 may also comprise a capillary tube, a linear polymer medium, a syringe and/or equivalent elements. The syringe may comprise a known mechanically driven syringe.

One useful type of polymer gripper is commercially available from Corning Incorporated, Corning N.Y., USA and is made of an environmentally stable polymer, which utilizes a photolithographic process to provide sub-micron accuracy. The polymer adheres to many materials including various glasses, crystals, ceramics, metals and polymers. Any patterns, curves, fan-outs, or squares, capable of being made using a photolithographic mask can be transformed onto a specified substrate.

The optical gel 15 surrounding the tube may advantageously be the same optical gel 10 in which the cells are embedded and/or chosen to match the refractive index of the cylindrical container 3. This allows the optical characteristics of the medium to remain substantially constant, even as the perspective presented to the objective 60 is varied. Thus, the tube is juxtaposed between the glass substrate 54 and a thin top coverslip 55 resulting in index matching between the two flat parallel surfaces. The index matching allows a nearly distortion free image to be acquired while still allowing the specimen to be easily rotated by turning the cylindrical container 3 at one or both ends using the motor 5. Immersing the cylindrical container 3 in the index matching material 15 also provides lubrication during rotation about the “θ” axis 49.

Index matching materials are commercially available (e.g. commercial sources include Nye Optical Gels, Dymax Corp, and Cargille Labs) and include, for example optical gels, oils and fluids of varying indices of refraction for reducing light reflection at optical interfaces. Optical gels are particularly useful where higher viscosity is desired and may comprise a medium of oil, gel, polymer epoxy, or other optically transparent materials that matches refractive indices of the surroundings. Specimens can be held in index-matching epoxy, embedding media, or plastic polymer as well as index-matching gels and viscous fluids.

The motor 5 may comprise any motor and/or motor and gear combination capable of precise speed control such as an electronic motor, a stepper motor or equivalent devices. In some embodiments the motor 5 comprised a microstepper motor that was used for its accuracy in angular positioning of a cell mounted in a microcapillary tube. However, the microstepper motor rotation is relatively slow and cumbersome though it provides better than 0.001 degree accuracy. In another useful embodiment, a small 6% noncumulative error in the full step of a stepper motor can be accepted without resorting to microstepping. Using a 5-phase stepper motor allows a full step size of about 0.72 degrees, resulting in an acceptable expected non-cumulative error of 0.0432 degrees. A 0.72 degree step size yields 250 projections for total rotation of 180 degrees. It is also possible to run the stepper motor at half-steps of 0.36 degrees if desired, though the position inaccuracy remains the same 0.0432 degrees. One commercially available 5-phase stepper motor, available from Nyden Corporation, CA, USA, is model PS533A which can be run at over 100 rpm, giving a 0.72 degree step time of 3.3 msec.

In another useful embodiment of the invention, continuous rotation of a cylindrical container, such as a microcapillary tube, has been found to be particularly advantageous. Continuous rotation of a cylindrical container adjusts for a tradeoff between the precision of rotation (i.e. how closely the tube rotates around an ideal, fixed axis) and any friction due to rotation of the tube relative to the pair of opposing polymer grippers. Some cases using a stepper motor exhibit friction that may cause a stick-slip motion such that the cylindrical container doesn't necessarily move the same amount for each step of non-continuous motion of the rotation stage. Such stick-slip motion leads to an angular error in reconstruction that can be overcome by employing continuous rotation, so that friction has only a dynamic component. Since the dynamic coefficient of friction is lower than the static friction coefficient, there is less friction in a continuous rotation case.

Another consideration while running in continuous rotation is possible rotational blurring of the image (pseudoprojection). It is estimated that 25% of the minimum system resolution of 0.5 micron (=0.125 micron) produces an acceptable 10% loss of contrast. Therefore, in one example, a rotational speed is selected such that the angle of rotation during the exposure time to form the pseudoprojection is as follows: acceptable angle of rotation=inv tan((0.125 micron)/(radius of pseudoprojection sweep=25 micron)=0.286 degrees. Using an exposure time of about 20 msec allows rotation at a speed of 0.286 degree/20 msec=14 degrees/sec. An exposure time of 1-2 msec, will yield a rotation speed of >180 degrees/sec.

In another useful embodiment, a sinusoidal velocity function may advantageously be employed for tube rotation. Using a sinusoidal velocity function, the rotational velocity never reaches zero, but oscillates between a low velocity and a higher velocity. The sinusoidal velocity function need not be a continuous motion, but may be regulated to sinusoidally vary the velocity so as to avoid stiction. The sinusoidal velocity function allows some slower movement to avoid rotational blur that may be increasingly evident as rotational velocity increases. Note also that there will inherently be a discrepancy between the drive function and the response of the tube. A microstepper motor may be used to produce a smooth sinusoidal rotational velocity function that overcomes such inertial effects.

Referring now to FIG. 6, there illustrated is an extrusion method of embedding the specimen in a solid medium, such as a linear polymer medium, as contemplated by one embodiment of the present invention. There shown is a slurry of particles 116 including a mixture of a mounting medium 110 and a specimen 114. The mounting medium 110 may advantageously be a polymeric solution or equivalent. In one useful application the specimen 114 comprises a biological specimen, including particles, as for example, at least one cell, biological cells harvested for cancer diagnosis, a cell nucleus, a nucleus, an embedded molecular probe and/or the like. Optionally, a micro-barcode source 112 may insert a micro-barcode into the slurry 116.

The slurry may be in a container 115 that is coupled to an injection device 117, wherein the container 115 may advantageously be a disposable container and the injection device 117 is a conventional injection molding device or equivalent. A linear polymer medium 103, comprising particles 101 emerges from the molding tube 118 and is cured by heat curing or ultra-violet absorption into a solid cylindrical container of polymer having embedded particles. In one embodiment of the apparatus of the invention, the injection device 117 operates to regulate the spacing between each object along the length of the linear polymer medium 103. The polymeric solution preferably comprises a polymer selected to be substantially transparent to visible light and provide, upon solidification and curing, a matching of its index of refraction with the index of refraction of a portion of the particles contained in the slurry 116.

The invention has been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by specifically different equipment, devices and algorithms, and that various modifications, both as to the equipment details and operating procedures, may be accomplished without departing from the true spirit and scope of the present invention.

What is claimed is:

1. A rotational system comprising:
a cylindrical container with a cylindrical container axis;
at least one pair of opposing polymer grippers, wherein the cylindrical container is inserted into the at least one pair of opposing polymer grippers; and
a motor coupled to rotate the cylindrical container.

2. The system of claim 1 wherein the at least one pair of opposing polymer grippers comprises a set of pillars fabricated on a glass substrate forming an inverted v-groove.

3. The system of claim 2 wherein the glass substrate comprises a microscope slide.

4. The system of claim 1 wherein the at least one pair of opposing polymer grippers restrains lateral motion of the cylindrical container orthogonal to the tube axis.

5. The system of claim 1 wherein the motor comprises a stepper motor.

6. The system of claim 5 wherein the stepper motor has a step size that produces a predetermined number of specimen views.

7. The system of claim 5 wherein the stepper motor has a step size of 0.72 degrees or less, thus generating at least 250 angular positions around 180 degrees of rotation.

8. The system of claim 1 further comprising index matching material encompassing the cylindrical container to provide a uniform optical medium.

9. The system of claim 8 wherein the index matching material comprises material selected from the group consisting of optical gels, oils, fluids, polymer and epoxy.

10. The system of claim 1 wherein the cylindrical container includes a specimen held in a medium selected from the group consisting of index-matching epoxy, embedding media, plastic polymer, index-matching gels and index-matching viscous fluids.

11. The system of claim 1 wherein the cylindrical container is selected from the group consisting of a microcapillary tube, a capillary tube, a linear polymer medium and a syringe.

12. A microcapillary tube rotational joint comprising:
a microcapillary tube with a tube axis;
at least one pair of opposing polymer grippers, wherein the microcapillary tube is inserted into the at least one pair of opposing polymer grippers; and
a motor coupled to rotate the microcapillary tube.

13. The system of claim 12 wherein the at least one pair of opposing polymer grippers comprises a set of pillars fabricated on a glass substrate forming an inverted v-groove.

14. The system of claim 13 wherein the glass substrate comprises a microscope slide.

15. The system of claim 14 wherein the at least one pair of opposing polymer grippers restrains lateral motion of the microcapillary tube orthogonal to the tube axis.

16. The system of claim 15 wherein the motor comprises a stepper motor.

17. The system of claim 16 wherein the stepper motor has a step size that produces a predetermined number of specimen views.

18. The system of claim 17 wherein the stepper motor has a step size of 0.72 degrees or less, thus generating at least 250 projections around 180 degrees of rotation.

19. The system of claim 12 further comprising index matching material encompassing the microcapillary tube to provide a uniform optical medium.

20. The system of claim 19 wherein the index matching material comprises material selected from the group consisting of optical gels, oils, fluids, polymer and epoxy.

21. The system of claim 12 wherein the microcapillary tube includes a specimen held in a medium selected from the group consisting of index-matching epoxy, embedding media, plastic polymer, index-matching gels and index-matching viscous fluids.

22. A microcapillary tube holder comprising:
a microcapillary tube;
at least one pair of opposing polymer grippers, wherein the microcapillary tube is inserted into the at least one pair of opposing polymer grippers, wherein the at least one pair of opposing polymer grippers comprises a set of pillars fabricated on a microscope slide, and wherein each of the at least one pair of opposing polymer grippers forms an inverted v-groove with the microscope slide adapted for clipping the microcapillary tube into place;
index matching material encapsulating the microcapillary tube to provide a uniform optical medium; and
a motor coupled to continuously rotate the microcapillary tube.

23. In a system for shadowgram formation for optical tomography including a piezoelectric transducer, an objective lens coupled to the piezoelectric transducer, a computer-controlled light source and condenser lens assembly, and a computer linked to control the piezoelectric transducer, the computer-controlled light source and condenser lens assembly, and the motor, and coupled to receive images from a video camera where the piezoelectric transducer axially moves the objective lens to scan a continuum of focal planes in the specimen during a single integration cycle of the video camera, a specimen assembly comprising:
a microcapillary tube containing a specimen disposed to be viewed through the objective lens;
at least one pair of opposing polymer grippers, wherein the microcapillary tube is inserted into the at least one pair of opposing polymer grippers; and
a motor coupled to rotate the microcapillary tube.

24. The system of claim 23 wherein the at least one pair of opposing polymer grippers comprises a set of pillars fabricated on a suitable glass substrate forming an inverted v-groove.

25. The system of claim 24 wherein the at least one pair of opposing polymer grippers also functions as at least one rotational joint for the microcapillary tube that restrains lateral motion orthogonal to the tube axis.

26. The system of claim 24 wherein the glass substrate comprises a microscope slide.

27. The system of claim 23 wherein the motor comprises a stepper motor.

28. The system of claim 27 wherein the stepper motor has a step size that produces a predetermined number of specimen views over a predetermined rotational range.

29. The system of claim 28 wherein the stepper motor has a step size of 0.72 degrees or less, thus generating at least 250 projections around 180 degrees of rotation.

30. The system of claim 23 further comprising index matching material surrounding the microcapillary tube.

31. The system of claim 30 wherein the index matching material comprises material selected from the group consisting of optical gels, oils, fluids, polymer and epoxy.

32. The system of claim 23 wherein the microcapillary tube includes a specimen held in a medium selected from the group consisting of index-matching epoxy, embedding media, plastic polymer, index-matching gels and index-matching viscous fluids.

33. The system of claim 23 wherein the specimen comprises a biological specimen stained with at least one of absorptive dyes, absorbing and light scattering dyes, antibody labels, antibodies conjugated with metal particles, quantum dots, plastic micro-spheres, fluorescent labels.

34. The system of claim 23 wherein the motor rotates continuously and/or sinusoidally to produce a predetermined number of specimen views.

35. A microcapillary tube holder comprising:
a microcapillary tube having a longitudinal tube axis;
at least one pair of opposing polymer grippers, wherein the microcapillary tube is inserted into the at least one pair of opposing polymer grippers;
index matching material encapsulating the microcapillary tube to provide a uniform optical medium;
a motor coupled to continuously rotate the microcapillary tube around the longitudinal tube axis; and
a means of injecting cells into the capillary tube to direct cell motion along the longitudinal tube axis.

36. The system of claim 35 wherein the at least one pair of opposing polymer grippers comprises a set of pillars fabricated on a glass substrate forming an inverted v-groove with the glass substrate.

37. The system of claim 35 wherein the at least one pair of opposing polymer grippers also functions as at least one rotational joint for the microcapillary tube that restrains lateral motion orthogonal to the longitudinal tube axis.

38. The system of claim 36 wherein the glass substrate comprises a microscope slide.

39. The system of claim 35 wherein the motor comprises a stepper motor.

40. The system of claim 39 wherein the stepper motor has a step size that produces a predetermined number of specimen views over a predetermined rotational range.

41. The system of claim 39 wherein the stepper motor has a step size of 0.72 degrees or less, thus generating at least 250 projections around 180 degrees of rotation.

42. The system of claim 35 further comprising index matching material surrounding the microcapillary tube.

43. The system of claim 42 wherein the index matching material comprises material selected from the group consisting of optical gels, oils, fluids, polymer and epoxy.

44. The system of claim 35 wherein the microcapillary tube includes a specimen held in a medium selected from the group consisting of index-matching epoxy, embedding media, plastic polymer, index-matching gels and index-matching viscous fluids.

45. The system of claim 35 wherein the specimen comprises a biological specimen stained with at least one of absorptive dyes, absorbing and light scattering dyes, antibody labels, antibodies conjugated with metal particles, quantum dots, plastic micro-spheres, fluorescent labels.

46. The system of claim 35 wherein the motor rotates continuously and/or sinusoidally to produce a predetermined number of specimen views.

47. The system of claim 35 wherein the motion along the longitudinal tube axis is generated with a mechanically driven syringe.

48. The system of claim 35 wherein the motion along the longitudinal tube axis is generated with a flow cytometer wherein laminar flow is achieved.
